(19) United States
(12) Patent Application Publication
(10) Pub. No.: US 2026/0027949 A1
(43) Pub. Date: Jan. 29, 2026

(54) ANTI-WINDUP CONTROL TECHNIQUES FOR OVERVOLTAGE MANAGEMENT IN FUEL CELL ELECTRIC VEHICLES

(71) Applicant: FCA US LLC, Auburn Hills, MI (US)

(72) Inventors: Zhentao Xie, Auburn Hills, MI (US); Rudolf Kharpuri, Auburn Hills, MI (US); Ali Achir, Poissy (FR)

(21) Appl. No.: 18/780,792

(22) Filed: Jul. 23, 2024

(51) Int. Cl. B60L 58/30; B60L 3/00; B60L 50/75; B60L 53/54; H01M 8/04537; H01M 8/04858; H01M 16/00; H02H 7/20

(52) U.S. Cl. CPC B60L 58/30; B60L 3/0046; B60L 50/75; B60L 53/54; H01M 8/04619; H01M 8/0494; H01M 16/006; H02H 7/20; B60L 2210/10; H01M 2220/20; H01M 2250/20

(57) ABSTRACT

An overvoltage management system for a fuel cell electric vehicle (FCEV) includes a power sensor configured to measure a power output by a fuel cell system of the FCEV, wherein the fuel cell system is configured to generate electric current for recharging a high voltage battery system of the FCEV and a control system to determine a power command for the fuel cell system, receive the measured power output by the fuel cell system, calculate a difference between the measured power output and the power command, and based on the calculated difference, control an integrator of a feedback controller for the fuel cell system to prevent windup of the feedback controller and an overvoltage malfunction of the high voltage battery system.

### FIELD

The present application generally relates to fuel cell electric vehicles (FCEVs) and, more particularly, to anti-windup control techniques for overvoltage management in FCEVs.

### BACKGROUND

A fuel cell electric vehicle (FCEV) includes a fuel cell system (e.g., a hydrogen fuel cell system) that is configured to perform a chemical reaction to generate electrical energy. This electrical energy can then be used, for example, to recharge a high voltage battery system of the FCEV, which is used to power one or more electric traction motors for vehicle propulsion. The actual output power of the fuel cell system cannot always meet a power command. This is due to saturation of the fuel cell system caused by various power and temperature limits. The integral action of a feedback controller could unnecessarily and continuously accumulate over time (also known as “windup”). This windup could result in a very large power command for the fuel cell system that could eventually cause overcharging and potentially damage to the high voltage battery system as shown in the example plot 10 of FIG. 1. Accordingly, while such conventional FCEV control systems do work for their intended purpose, there exists an opportunity for improvement in the relevant art.

### SUMMARY

According to one example aspect of the invention, an overvoltage management system for a fuel cell electric vehicle (FCEV) is presented. In one exemplary implementation, the overvoltage management system comprises a power sensor configured to measure a power output by a fuel cell system of the FCEV, wherein the fuel cell system is configured to generate electric current for recharging a high voltage battery system of the FCEV and a control system to determine a power command for the fuel cell system, receive the measured power output by the fuel cell system, calculate a difference between the measured power output and the power command, and based on the calculated difference, control an integrator of a feedback controller for the fuel cell system to prevent windup of the feedback controller and an overvoltage malfunction of the high voltage battery system.

In some implementations, the control system is configured to update or recalculate an integral term of the integrator based on the calculated difference. In some implementations, the calculated difference is a negative value, and wherein the control system is configured to add the calculated difference to the integral term. In some implementations, the control system is configured to set an output of a gain of the integrator to zero. In some implementations, the control system is configured to set a gain of the integrator to zero. In some implementations, the control system is configured to not update the calculation of an integral term of the integrator.

In some implementations, the fuel cell system is a hydrogen fuel cell system that becomes saturated due to warm-up power limits, and wherein the saturation of the fuel cell system temporarily prevents the fuel cell system from increasing its output power. In some implementations, the saturation is further due to at least one of (i) temperature limits of the FCEV, (ii) power limits of a direct current (DC) to DC converter arranged between the fuel cell system and the high voltage battery system, and (iii) charging power limits of the high voltage battery system. In some implementations, the high voltage system is configured to power one or more electric traction motors of the FCEV.

According to another example aspect of the invention, an overvoltage management method for an FCEV is presented. In one exemplary implementation, the overvoltage management method comprises determining, by a control system of the FCEV, a power command for a fuel cell system of the FCEV, wherein the fuel cell system is configured to generate electric current for recharging a high voltage battery system of the FCEV, receiving, by the control system and from a power sensor, a measured power output by the fuel cell system, calculating, by the control system, a difference between the measured power output and the power command, and controlling, by the control system, an integrator of a feedback controller for the fuel cell system based on the calculated difference to prevent windup of the feedback controller and an overvoltage malfunction of the high voltage battery system.

In some implementations, the controlling of the integrator includes updating or recalculating, by the control system, an integral term of the integrator based on the calculated difference. In some implementations, the calculated difference is a negative value, and wherein the updating or recalculating of the integral term includes adding, by the control system, the calculated difference to the integral term. In some implementations, the controlling of the integrator includes setting, by the control system, an output of a gain of the integrator to zero. In some implementations, the controlling of the integrator includes setting, by the control system, a gain of the integrator to zero. In some implementations, the controlling of the integrator includes not updating, by the control system, the calculation of an integral term of the integrator.

In some implementations, the fuel cell system is a hydrogen fuel cell system that becomes saturated due to warm-up power limits, and wherein the saturation of the fuel cell system temporarily prevents the fuel cell system from increasing its output power. In some implementations, the saturation is further due to at least one of (i) temperature limits of the FCEV, (ii) power limits of a DC to DC converter arranged between the fuel cell system and the high voltage battery system, and (iii) charging power limits of the high voltage battery system. In some implementations, the high voltage system is configured to power one or more electric traction motors of the FCEV.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a plot illustrating an example overvoltage malfunction in a fuel cell electric vehicle (FCEV) according to the prior art;

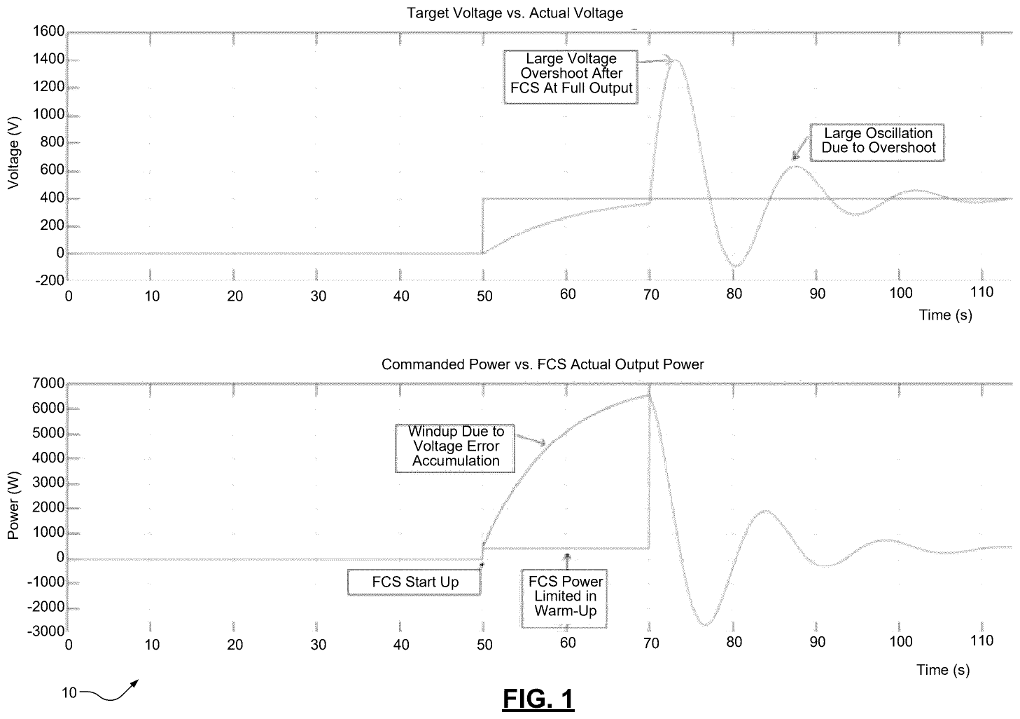

FIG. 2 is a diagram of a FCEV having an example overvoltage management system according to the principles of the present application;

FIG. 3 is a diagram of an example architecture for the overvoltage management system according to the principles of the present application;

FIG. 4 is a flow diagram of an example overvoltage management method for an FCEV according to the principles of the present application; and

FIG. 5 is a plot illustrating example overvoltage management in an FCEV according to the principles of the present application.

### DESCRIPTION

As previously discussed, the actual output power of a fuel cell system (e.g., a hydrogen fuel cell system) of a fuel cell electric vehicle (FCEV) cannot always meet a power command. This is due to saturation of the fuel cell system caused by warm-up power limits, temperature limits, direct current to direct current (DC-DC) converter power limits, battery charge power limits, and the like. In one exemplary implementation, the FCEV includes a supervisory controller (e.g., an electrified vehicle control unit, or EVCU), with a motor control processor (MCP) controlling the electric motor(s) and related devices (e.g., an inverter) and a fuel cell processor (FCP) controlling the fuel cell system. The integral action of a feedback controller (e.g., a proportional-integral-derivative, or PID controller) could unnecessarily and continuously accumulate over time (also known as “windup”). This windup could result in a very large power command from the EVCU that could eventually cause overcharging and potentially damage to the high voltage battery system. The MCP's operation could also be altered in response to these voltage oscillations, which could result in a noticeable torque fluctuation.

Accordingly, anti-windup control techniques for overvoltage management in FCEVs are presented herein. These techniques utilize a power sensor at an output of the fuel cell system and this output power is compared to the EVCU power command. The integrator of the fuel cell system feedback controller is then controlled to prevent the above-described windup and thereby avoid overvoltage malfunctions of the high voltage battery system. This control of the integrator could be performed in a variety of different manners that counteract the accumulated error due to the fuel cell system saturation. For example, (1) the K-I gain output could be set to zero (the planned implementation), (2) the K-I gain could be set to zero, or (3) the integrator calculation could not be updated. Potential benefits of these techniques include decreased warranty costs by preventing overvoltage malfunctions and extending the life of the high voltage battery system and also avoiding torque fluctuations due to inadvertent control adjustments by the MCP and the electric motor system.

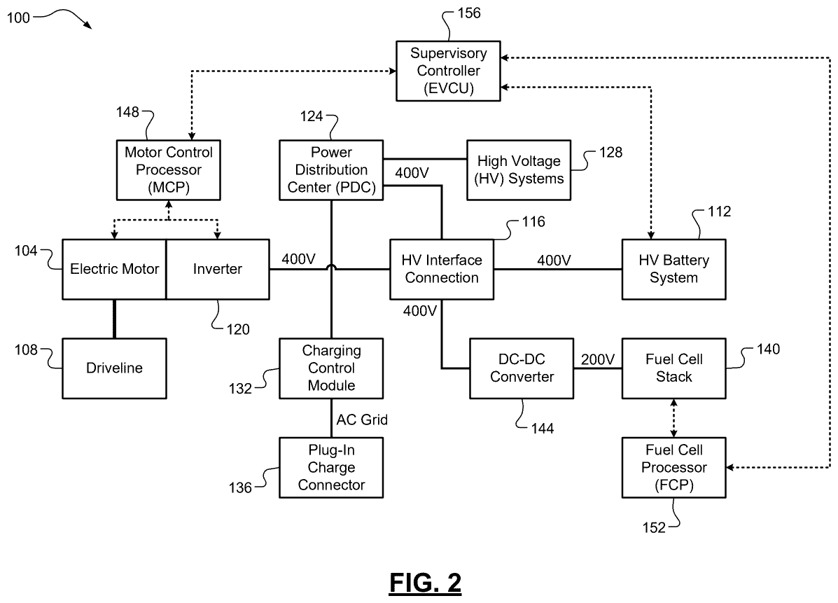

Referring now to FIG. 2, a diagram of a FCEV 100 having an example overvoltage management system according to the principles of the present application is illustrated. The FCEV 100 is controlled by a supervisory controller (EVCU) 156 and comprises one or more electric motors 104 (e.g., a three-phase electric traction motor) configured to generate drive torque that is transferred directly or via a transmission (not shown) to a driveline 108 of the FCEV 100 or to generate regenerative power by converting mechanical energy from the driveline 108. The electric motor 104 connected to a high voltage (HV) DC bus and to a HV battery system 112 (a HV battery pack, a battery pack control module (BPCM), HV contactors, etc.) via a HV interface connection 116 and a three-phase inverter 120, which are controlled by an MCP 148. While the HV DC bus is shown to be 400V DC, it will be appreciated that the FCEV 100 could be powered by a different HV DC power magnitude (e.g., 800V DC).

The HV DC bus is also connected to a power distribution center (PDC) 124, which is connected to other HV systems 128 (an electric air compressor, one or more electric heaters, etc.) and also to a charging control module 132 (e.g., an on-board charging module, or OBCM, or integrated dual charging module, or IDCM). The charging control module 132 is selectively connectable to external alternating current (AC) power, such as an AC grid or charging station, via a plug-in charge connector 136. The fuel cell system comprises a fuel cell stack 140 (e.g., a hydrogen fuel cell stack) configured to perform a chemical reaction to generate and output another different HV DC power and is controlled by an FCP 152. While this other different HV DC power is shown to be 200V, it will be appreciated that the fuel cell stack/system could be configured to output a lesser or greater HV DC power magnitude. A DC-DC converter 144 is configured to step-up or boost the lower HV DC power output by the fuel cell stack/system (e.g., 200V DC) to the higher HV DC power at the HV interface connection 116 (e.g., 400V DC).

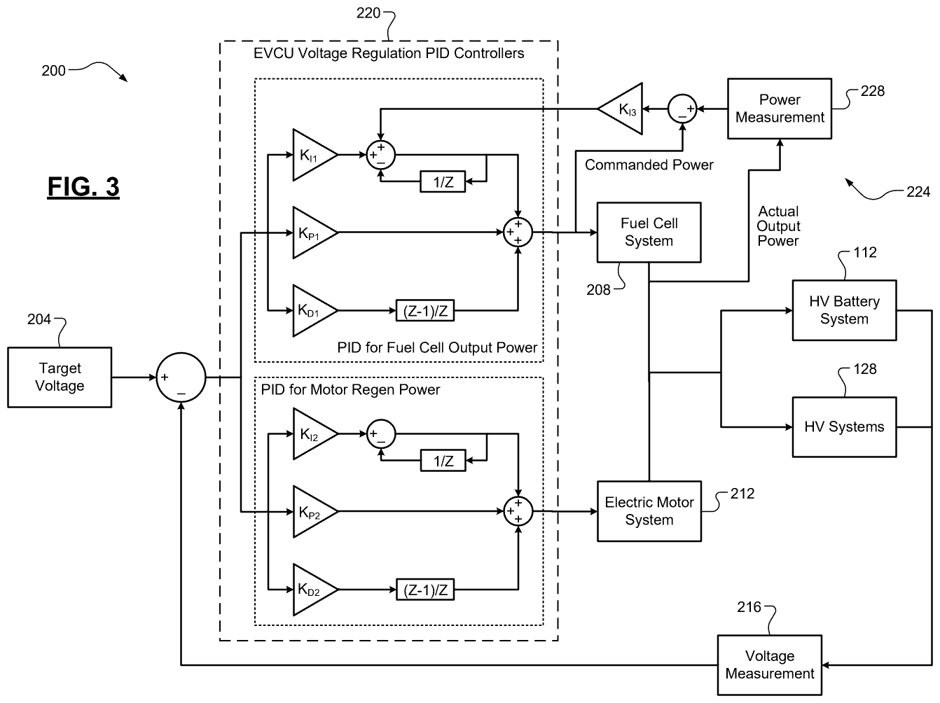

Referring now to FIG. 3 and with continued reference to FIG. 2, a diagram of an example architecture 200 of the overvoltage management system according to the principles of the present application is illustrated. Initially, a target voltage determination 204 is performed to determine a target voltage to be collectively generated by the fuel cell system 208 (e.g., including the fuel cell stack 140, the DC-DC converter 144, and the FCP 152) and the electric motor system 212 (e.g., including the electric motor 104, the inverter 120, and the MCP 148). This target voltage is based, for example, on a driver torque request and other operating parameters of the FCEV 100. This target voltage is adjusted based on feedback error as measured by a voltage measurement block 216, which measures a voltage at the outputs of the HV battery system 112 and the HV systems 128. The EVCU 156 includes two separate PID feedback controllers 220: (1) a PID for the output power of the fuel cell system 208 and (2) a regenerative power to be generated by the electric motor system 212.

Each of these PID feedback controllers 220 includes a respective integral gain (K_{I1}, K_{I2}), a respective proportional gain (K_{P1}, K_{P2}), and a respective derivative gain (K_{D1}, K_{D2}), as well as transfer functions (1/Z) and ([Z−1]/Z). The sums of the respective integral, proportional, and derivative terms are the output of each PID feedback controller 220 to the respective system (i.e., the fuel cell system 208 and the electric motor system 212). The architecture 200 further includes an anti-windup system or feature 240, which includes a power measurement block 228 (e.g., a power sensor) that measures the actual output power (P_{ACT}) of the fuel cell system 208 (e.g., the fuel cell stack 140), calculates a difference (P_{DIFF}) between the actual output power P_{ACT} and the commanded power (P_{CMD}) by the EVCU 156 (P_{DIFF}=P_{ACT}−P_{CMD}). A third integral gain (K_{I3}) could be applied to this difference P_{DIFF}, which is then fed back into the integral term of the integrator of the PID feedback controller 220 for the fuel cell output power. During windup, this value P_{DIFF} will be negative (<0), and thus it will decrease the integral term from accumulating until the fuel cell system 208 is capable of achieving an output power P_{ACT} satisfying the commanded power P_{CMD}.

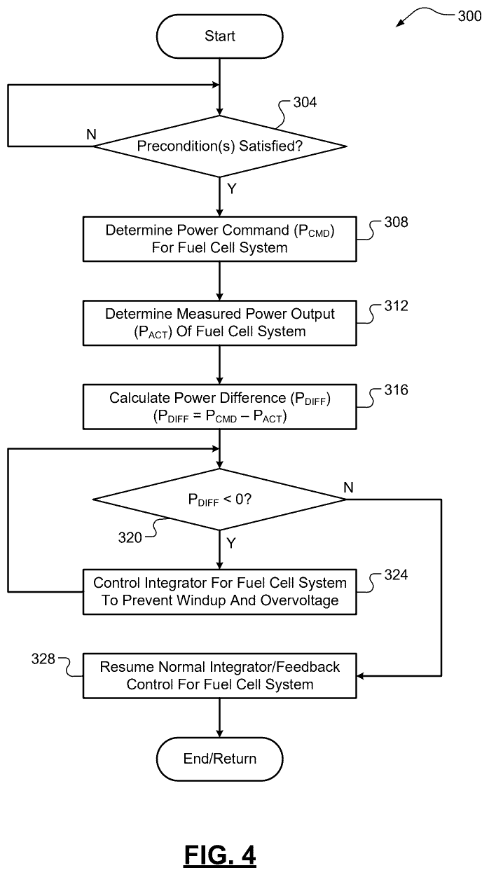

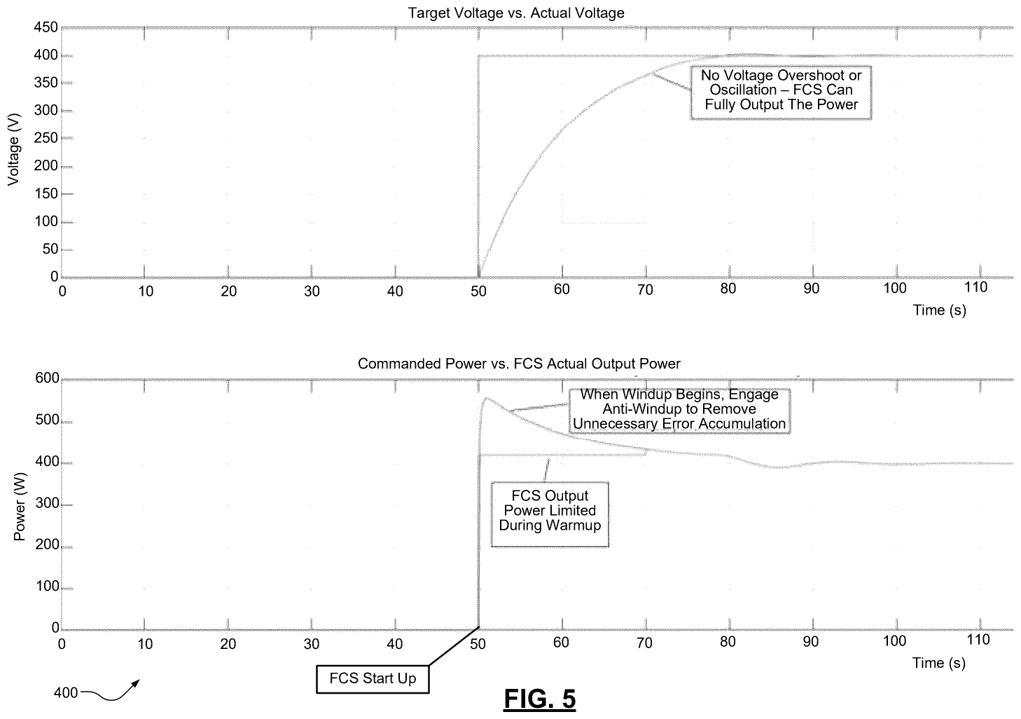

Referring now to FIG. 4 and with continued reference to FIGS. 2-3, a flow diagram of an example method 300 for overvoltage management in a FCEV according to the principles of the present application is illustrated. While the components of the FCEV 100 and the architecture 200 are specifically referenced for illustrative/descriptive purposes, it will be appreciated that the method 300 could be applicable to any suitably configured FCEV. The method 300 begins at 304 where the EVCU 156 optionally determines whether a set of one or more preconditions are satisfied. This could include, for example only, the fuel cell system 208 being powered up and there being no malfunctions or faults present that would otherwise inhibit or negatively impact the operation of the techniques of the present application. When false, the method 300 ends or returns to 304. When true, the method 300 proceeds to 308. At 308, the EVCU 156 determines the power command P_{CMD} for the fuel cell system 208. At 312, the EVCU 156 measures (e.g., using the power sensor 244) the actual output power P_{ACT} of the fuel cell system 208. At 316, the EVCU 156 calculates the difference P_{DIFF} between the actual output power P_{ACT} and the power command P_{CMD}. At 320, the EVCU 156 determines whether the difference P_{DIFF} is less than zero. When true, the method 300 proceeds to 324 where the EVCU 156 controls the integrator for the fuel cell system 208 to prevent windup and an overvoltage malfunction as shown in the plot 400 of FIG. 5. The method 300 then returns to 320. Once the difference P_{DIFF} is greater than zero, the method 300 proceeds to 328 where normal integrator/feedback control resumes and the method 300 then ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An overvoltage management system for a fuel cell electric vehicle (FCEV), the overvoltage management system comprising:
a power sensor configured to measure a power output by a fuel cell system of the FCEV, wherein the fuel cell system is configured to generate electric current for recharging a high voltage battery system of the FCEV; and
a control system to:
determine a power command for the fuel cell system;
receive the measured power output by the fuel cell system;
calculate a difference between the measured power output and the power command; and
based on the calculated difference, control an integrator of a feedback controller for the fuel cell system to prevent windup of the feedback controller and an overvoltage malfunction of the high voltage battery system.

2. The overvoltage management system of claim 1, wherein the control system is configured to update or recalculate an integral term of the integrator based on the calculated difference.

3. The overvoltage management system of claim 2, wherein the calculated difference is a negative value, and wherein the control system is configured to add the calculated difference to the integral term.

4. The overvoltage management system of claim 1, wherein the control system is configured to set an output of a gain of the integrator to zero.

5. The overvoltage management system of claim 1, wherein the control system is configured to set a gain of the integrator to zero.

6. The overvoltage management system of claim 1, wherein the control system is configured to not update the calculation of an integral term of the integrator.

7. The overvoltage management system of claim 1, wherein the fuel cell system is a hydrogen fuel cell system that becomes saturated due to warm-up power limits, and wherein the saturation of the fuel cell system temporarily prevents the fuel cell system from increasing its output power.

8. The overvoltage management system of claim 7, wherein the saturation is further due to at least one of (i) temperature limits of the FCEV, (ii) power limits of a direct current (DC) to DC converter arranged between the fuel cell system and the high voltage battery system, and (iii) charging power limits of the high voltage battery system.

9. The overvoltage management system of claim 8, wherein the high voltage system is configured to power one or more electric traction motors of the FCEV.

10. An overvoltage management method for a fuel cell electric vehicle (FCEV), the overvoltage management method comprising:
determining, by a control system of the FCEV, a power command for a fuel cell system of the FCEV, wherein the fuel cell system is configured to generate electric current for recharging a high voltage battery system of the FCEV;
receiving, by the control system and from a power sensor, a measured power output by the fuel cell system;
calculating, by the control system, a difference between the measured power output and the power command; and
controlling, by the control system, an integrator of a feedback controller for the fuel cell system based on the calculated difference to prevent windup of the feedback controller and an overvoltage malfunction of the high voltage battery system.

11. The overvoltage management method of claim 10, wherein the controlling of the integrator includes updating or recalculating, by the control system, an integral term of the integrator based on the calculated difference.

12. The overvoltage management method of claim 11, wherein the calculated difference is a negative value, and wherein the updating or recalculating of the integral term includes adding, by the control system, the calculated difference to the integral term.

13. The overvoltage management method of claim 10, wherein the controlling of the integrator includes setting, by the control system, an output of a gain of the integrator to zero.

14. The overvoltage management method of claim 10, wherein the controlling of the integrator includes setting, by the control system, a gain of the integrator to zero.

15. The overvoltage management method of claim 10, wherein the controlling of the integrator includes not updating, by the control system, the calculation of an integral term of the integrator.

16. The overvoltage management method of claim 10, wherein the fuel cell system is a hydrogen fuel cell system that becomes saturated due to warm-up power limits, and wherein the saturation of the fuel cell system temporarily prevents the fuel cell system from increasing its output power.

17. The overvoltage management method of claim 16, wherein the saturation is further due to at least one of (i) temperature limits of the FCEV, (ii) power limits of a direct current (DC) to DC converter arranged between the fuel cell system and the high voltage battery system, and (iii) charging power limits of the high voltage battery system.

18. The overvoltage management method of claim 17, wherein the high voltage system is configured to power one or more electric traction motors of the FCEV.
